(19) United States
(12) Patent Application Publication
(10) Pub. No.: US 2026/0094776 A1
(43) Pub. Date: Apr. 2, 2026

(54) Programmable and Configurable Switch Assembly

(71) Applicant: Stein Industries, Inc., Brooklyn Park, MN (US)

(72) Inventors: Curtis Bakken, Brooklyn Park, MN (US); Joseph Paul Farr, Brooklyn Park, MN (US); Clive Richard Maxfield, Brooklyn Park, MN (US); Stephen Robert Pollock, Brooklyn Park, MN (US); Jason Wagner, Brooklyn Park, MN (US)

(21) Appl. No.: 19/346,149

(22) Filed: Sep. 30, 2025

Related U.S. Application Data
(60) Provisional application No. 63/701,418, filed on Sep. 30, 2024.

(51) Int. Cl. H01H 9/16; H01H 47/00

(52) U.S. Cl. CPC H01H 9/168; H01H 9/161; H01H 9/167; H01H 47/001; H01H 2300/03

(57) ABSTRACT

The subject matter of this specification can be embodied in, among other things, an electrical switch assembly that includes an electrical switch and a communication transceiver electrically and mechanically coupled to the electrical switch and configured to transmit a digitally encoded representation of a configuration status of the electrical switch.

### CROSS-REFERENCE TO RELATED APPLICATION

This application claims the benefit under 35 U.S.C. § 119 (e) of U.S. Patent Application No. 63/701,418, filed on Sep. 30, 2024. The disclosure of the foregoing application is incorporated herein by reference in its entirety for all purposes.

### TECHNICAL FIELD

This instant specification relates to switch assemblies with integrated communication transceivers, for example switch assemblies with integrated communication transceivers configured for CANBUS communication.

### BACKGROUND

Panel mounted pushbutton switches are a form of user input commonly found in control systems. These switches are typically installed on a control panel or console, allowing operators to easily engage or disengage circuits without the need for complex commands or procedures. The design of these switches varies widely to suit different applications, ranging from simple, non-illuminated buttons to complex, multi-function devices with integrated LED indicators. These switches are used in a wide variety of industries, including automotive, aerospace, and manufacturing.

Automation and control systems typically implement digital computers or controllers. Such controllers are commonly configured to receive user input through panel mounted pushbutton switches. However, mechanical pushbutton switches can exhibit switch “bounce,” in which electrical continuity across the switch is made and broken multiple times as the switch transitions from off to on and vice versa. Switch bounce can cause a controller to interpret a single switch transition as a rapid series of switch transitions, which can cause the controller to misinterpret the user's intent. Furthermore, the wiring used to connect a switch to the inputs on a controller can add complexity and cost to a control system and can act as antennas to pick up unwanted ambient electrical noise.

### SUMMARY

In general, this document describes switch assemblies with integrated communication transceivers. In general, this document describes “smart” industrial (e.g., environmentally sealed, vandal resistant) switches or buttons. These switches include electronics that can communicate over a digital communication bus and transmit pre-configurable digitally encoded messages over the digital communication bus in response to user interactions (e.g., presses, touches, releases) with the switches. In general, the switches are provided, installed, and used as a unit (e.g., button and communication electronics in a single package), and are factory or field configurable.

The systems and techniques described here may provide one or more of the following advantages. First, a system can provide flexible, field-configurable user input functionality. Second, the system can increase the speed and ease of adding switches and buttons to new control systems. Third, the system can increase the speed and ease of retrofitting existing control systems with additional switches and buttons. Fourth, the system can reduce the amount and complexity of wiring in control systems. Fifth, the system can make control systems more immune to electrical (radio frequency, RF) noise. Sixth, the system can include features that promote thermal management of heat generated by onboard electronic components. Seventh, the system can be packaged in form factor that does not interfere with traditional methods of assembling switches into control panels.

The details of one or more implementations are set forth in the accompanying drawings and the description below. Other features and advantages will be apparent from the description and drawings, and from the claims.

### DESCRIPTION OF DRAWINGS

FIG. 1 is a perspective front view of an example switch assembly.

FIG. 2 is a block diagram of an example switch communication system.

FIG. 3 is a block diagram of an example switch assembly.

FIG. 4 is an exploded perspective rear view of the example switch assembly.

FIG. 5. is an exploded side view of the example switch assembly.

FIG. 6 is another exploded perspective rear view of the example switch assembly.

FIG. 7 is another exploded perspective rear view of the example switch assembly.

FIG. 8 is another exploded side view of the example switch assembly.

FIG. 9 is another side view of the example switch assembly.

FIG. 10 is a rear view of the example switch assembly.

FIGS. 11A and 11B are front and top views of an example switch panel assembly.

FIG. 12 is a flow diagram of an example process for assembling a switch assembly.

FIG. 13 is a flow diagram of an example process for using an example switch assembly.

FIG. 14 is a block diagram of computing devices that may be used to implement the systems and methods described in this document.

FIG. 15 is a perspective side view of an example switch assembly.

FIG. 16 is an example user interface for programming a switch assembly.

### DETAILED DESCRIPTION

This document describes systems and techniques assembling and using programmable and configurable switch assemblies. In general, this document describes “smart” industrial (e.g., environmentally sealed, vandal resistant) switches or buttons. These switches include electronics that can communicate over a digital communication bus and transmit pre-configurable digitally encoded messages over the digital communication bus in response to user interactions (e.g., presses, touches, releases) with the switches. In general, the switches are provided, installed, and used as a unit (e.g., button and communication electronics in a single package), and are factory or field configurable.

In operation, the switches can be quickly installed in a control panel (e.g., in substantially the same way as a traditional switch) and plugged into a digital communication bus such as a CANBUS bus. The switches can then be configured to exhibit one or more predetermined behaviors (e.g., on, off, toggle) to send one or more predetermined messages in response to different predetermined user inputs (e.g., presses, releases, multiple presses). In the example of a CANBUS implementation, the switch can be added to an existing CANBUS-based network and can be configured to send messages that another peer device is already configured to recognize and respond to. In examples such as this, user interfaces (e.g., control panels) can be assembled and or modified quickly to enable new or additional user functionality without requiring the use of new tools or new controllers, or reconfiguration of existing controllers.

Although the examples discussed in this document describe digital communications in the context of CANBUS communications, other embodiments are contemplated. In some embodiments, the switches described herein can be adapted to communicate using any appropriate digital or analog communication protocol and/or media. For example, the switches described herein can be adapted to use communications protocols such as NMEA, RS-232, RS-485, RS-422, Ethernet, TCP/IP, UDP, UART, I2C, USB, MODBUS, PROFIBUS, MATTER, or any other appropriate serial or parallel communications format and any appropriate wired or optical communication media. In another example, the switches described herein can be adapted to communicate using any appropriate wireless communication protocol and/or media, such as BLUETOOTH, BLUETOOTH LE (BLE), wireless Ethernet (Wi-Fi), ZWAVE, ZIGBEE, THREAD, LoRa, NB-IOT, NFC, GSM, 3G, 4G, 5G.

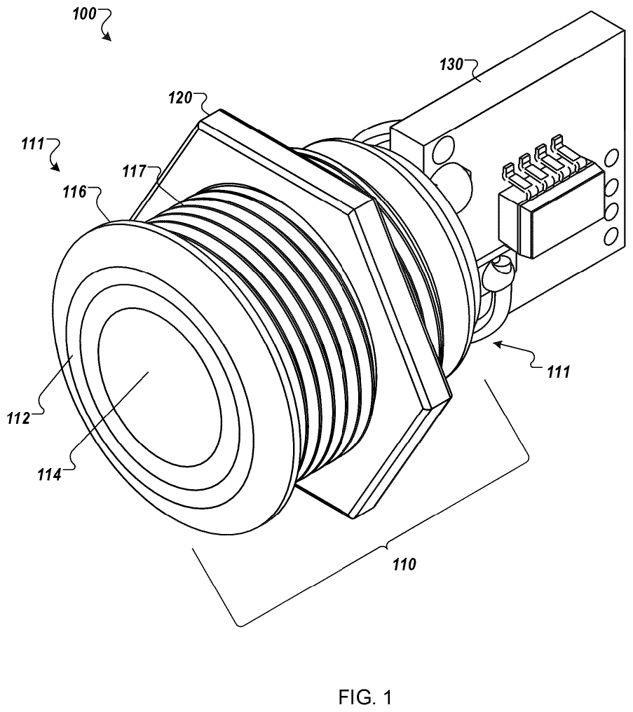

FIG. 1 is a perspective front view of an example electrical switch assembly 100. In the illustrated example, the assembly 100 is an electrical switch apparatus that includes a panel-mount pushbutton electrical switch 110 with a configurable illuminator 112 (e.g., an integrated RGB LED indicator light) formed as a ring that coaxially surrounds a button 114. The switch 110 has a housing 111 that is configured to be mounted in a hole formed in a panel or other surface. The housing 111 includes a shoulder 116 that is configured to abut a front surface of the panel, and a thread 117 about an outer periphery of the housing 111 that is configured to pass through a mounting hole or aperture in the panel. A nut 120 can be threaded over the thread to abut a rear surface of the panel and secure the switch assembly 100 in place.

The button 114 is configured to be depressed in order to alter a configuration of the switch 110 (e.g., on or off). In some embodiments, the switch 110 can be a latching or momentary switch that is normally-open or normally-closed. In some embodiments, the switch can be a toggle switch (e.g., push on, push off). As will be discussed in more detail below, in some embodiments the switching behavior of the switch 110 and the assembly 100 can be dynamically configured.

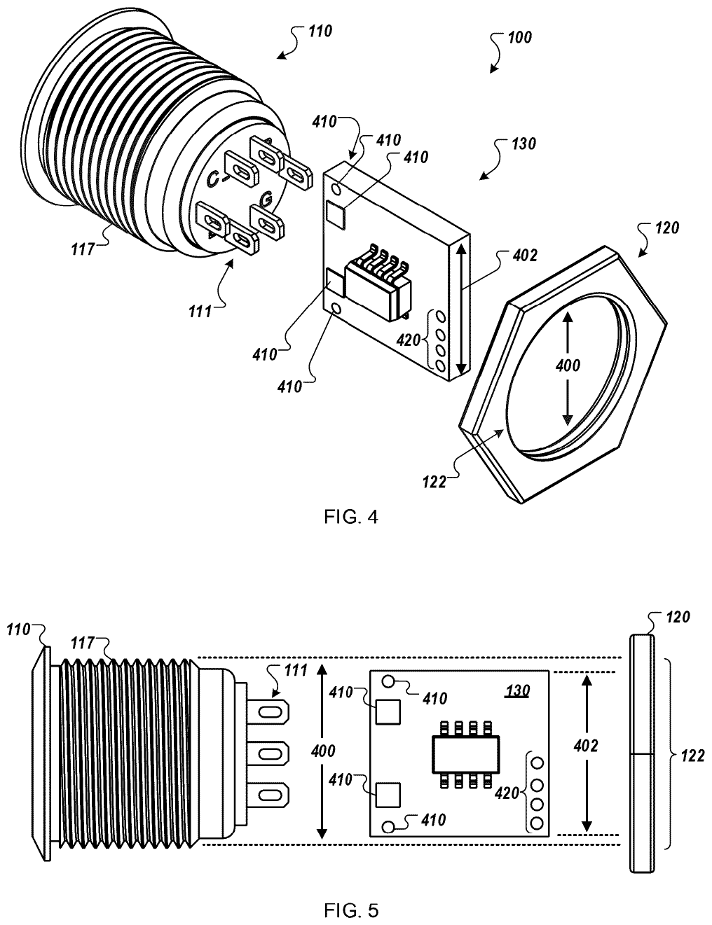

A communication transceiver configured as a printed circuit board (PCB) 130 is soldered to a collection of pins 111 (not visible in this view but will be shown and discussed in the descriptions of FIGS. 4-10) on the backside of the switch 110. The PCB 130 is configured to perform various functions, such as receive input (e.g., sense the configuration status of the switch 110 and convert the status into communication signals for output), output signals (e.g., transmit digitally encoded representations of the state of the switch 110 to external devices or systems), receive configuration signals (e.g., accept communication signals from an external controller to configure the operational behavior of the switch assembly 100), control LED indicator (e.g., manage the activation state of the configurable illuminator 112 based on received illumination commands), and control local switching (e.g., open or close a relay or other electrical control within the switch assembly 100). The PCB 130 is capable of both transmitting and receiving digital serial communication signals. This allows for dynamic configuration and control of the switch 110 and/or the configurable illuminator 112.

The PCB 130 is configured to receive illumination commands from a communication bus and control the operation of the configurable illuminator 112 to provide visual feedback, such as by illuminating (e.g., turning on or off, flashing, altering brightness, displaying one or more colors and/or patterns) to indicate the configuration status of the switch or other system states as configured by an external controller. For example, the circuitry and/or processor(s) of the PCB 130 can be configured to turn the configurable illuminator 112 on when the switch 110 is closed and turn the configurable illuminator 112 off when the switch 110 is opened. In another example, the circuitry and/or processor(s) of the PCB 130 can be configured to listen for and respond to predetermined messages sent by other devices over the communication bus and respond by altering the illumination configuration of the configurable illuminator (e.g., listen for a message that represents that a peer device is active and respond by turning the configurable illuminator on, listen for an “error” message and respond by making the configurable illuminator flash red).

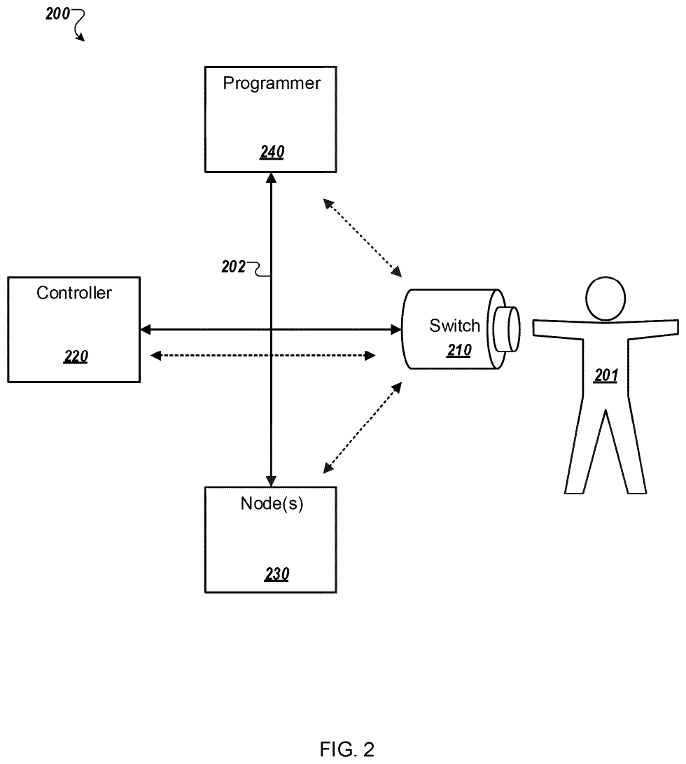

FIG. 2 is a block diagram of an example switch communication system 200. The system 200 includes a switch assembly 210. In some embodiments, the switch assembly 210 can be the example switch assembly 100 of FIG. 1. The switch assembly 210 is configured to be activated (e.g., pressed to alter a configuration status of the switch) and/or observed by a user 201.

The switch assembly 210 includes a communication transceiver that is in communication (e.g., wired or wireless) with a communication bus 202. In some embodiments, the communication bus 202 can be any appropriate communication bus using any appropriate electronic communication protocol. For example, the communication bus 202 can implement CANBUS, NMEA, RS-232, RS-485, RS-422, Ethernet, TCP/IP, UDP, UART, I2C, USB, MODBUS, PROFIBUS, MATTER, BLUETOOTH, BLUETOOTH LE (BLE), wireless Ethernet (Wi-Fi), ZWAVE, ZIGBEE, THREAD, LoRa, NB-IOT, NFC, GSM, 3G, 4G, 5G, or combinations or these and/or any other appropriate communication protocols and media.

The communication bus 202 communicatively connects the switch assembly 210 with one or more remote devices such as a controller 220, one or more node devices 230, and a programmer device 240. The controller 220 and/or the node devices 230 can be configured to receive and respond to messages communicated over the communication bus 202 (e.g., transmitted by the switch assembly 210). The switch assembly 210 can be configured to receive and respond to messages communicated over the communication bus 202 (e.g., transmitted by the controller 220 and/or the node devices 230).

In some implementations, the switch assembly 210 can be configured to broadcast messages over the communication bus 202. For example, in a CANBUS system the various nodes of the network act as peers in which generally any node can transmit messages and all of the other nodes will receive the messages, and each listener can be configured to determine if/how to react to each message. In such examples, the switch assembly 210 can be added to an existing peer network and be configured to transmit digitally encoded representations of the status of the switch assembly 210 as messages that other peers can react to without requiring reconfiguration of the other peers.

In some implementations, the switch assembly 210 can be configured to send addressed messages over the communication bus 202. For example, in a TCP/IP system the various nodes of the network can each have a unique network address. In such examples, the switch assembly 210 can be added to an existing peer network and be configured to transmit messages that are addressed to specific peers, and those peers can receive those messages and react to without requiring reconfiguration.

A programmer 240 is used to configure the switch assembly 210. For example, the programmer 240 can communicate with the switch assembly 210 over the communication bus 202 to send switch configuration parameters that configure how the switch assembly 210 will respond to input from the user 201 (e.g., act as a momentary switch, act as a latching switch, act as a toggle switch) and/or sequences of user inputs (e.g., perform a first action in response to a single press, perform a different action in response to a double-press). In another example, the programmer 240 can configure messages that switch assembly 210 will send in response to input from the user 201 (e.g., transmit an “on” message for the node 230 to react to when the switch assembly 210 is pressed, transmit an “off” message to the controller 220 when the switch assembly 210 is released).

For example, the switch assembly 210 can be configured in various operational modes. Some examples can include:

| Mode | First Depress | First Release | Second Depress | Second Release |
|---|---|---|---|---|
| 0 | Send Message 1 | | Send Message 1 | |
| 1 | Send Message 1 | Send Message 2 | Send Message 1 | Send Message 2 |
| 2 | Send Message 1 | | Send Message 2 | |
| 3 | Send Message 1 | Send Message 2 | Send Message 3 | Send Message 4 |

In such examples, Mode 0 only sends a predetermined message when the switch is depressed (e.g., like a traditional push switch). Mode 1 sends a predetermined message when the switch is pressed, then a different predetermined message when the switch is released. Mode 2 is a toggle function similar to a latching pushbutton action. Mode 3 is a complex function that can send different predetermined messages for successive depressions and releases.

The programmer 240 can also be used to configure how feedback is provided to the user 201. For example, the switch assembly 210 can includes an indicator light that can be configured to turn on and off or change colors or brightness as the switch assembly 210 is pressed and released. In some embodiments, the switch assembly 210 can be configured to listen to messages on the communication bus 202 and respond to predetermined messages in a predetermined way. For example, the switch assembly 210 can be configured to turn on and off in response to broadcasts from the node 220 that indicate that the node 220 is active or idle. In another example, the switch assembly 210 can be configured to flash red when the controller 230 broadcasts an “error” or “emergency stop” message.

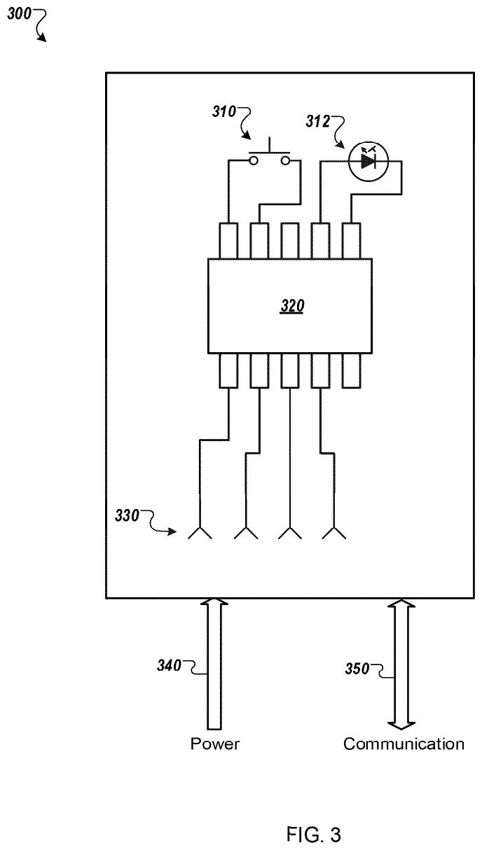

FIG. 3 is a block diagram of an example switch assembly 300. In some embodiments, the switch assembly 300 can be the example switch assembly 100 of FIG. 1. The assembly 300 includes a switch 310 that can be pressed or otherwise activated to change it between and electrically closed and open configuration), a configurable illuminator 312 (e.g., and RGB LED light ring), a communication transceiver 320 configured to read the open and/or closed configuration status of the switch 310 and transmit messages based on the configuration status of the switch 310, and a collection of input/output contacts 330.

The assembly 300 is configured to receive power 340 from a power bus and is configured to transmit and receive communication messages 350 to and from a communication bus. In general, the power and communication busses are electrically connected to the switch assembly at the input/output contacts 330. In some embodiments, the power and communication busses can be combined (e.g., I2C, Power Over Ethernet). In some embodiments, one or both of the power and communication busses can be wireless (e.g., RFID, BLUETOOTH, NFC, inductive power and/or communications).

In some embodiments, the assembly 300 can be configured to operate from around 7V DC to 24V DC and tolerate up to 30V DC for brief spikes. The assembly 300 can include power regulators that convert incoming power to levels that the rest of the electronics of the assembly 300 can safely use. The transceiver 320 can have the ability to detect brown outs and enable watchdog self-protection to force onboard processors to restart if needed.

FIG. 4 is an exploded perspective rear view of the example switch assembly 100. FIG. 5. is an exploded side view of the example switch assembly 100. These views show the collection of pins 111 that were not visible in FIG. 1.

In these views, it can be seen that the nut 120 defines a threaded hole 122 that is configured to threadedly engage with the thread 117. The threaded hole 122 has a diameter 400 that is larger than a largest dimension 402 of the PCB 130. As will be described in more detail below, this allows the PCB 130 to be passed through the threaded hole 122 as the nut 120 is assembled to the switch 110.

Also visible in these views are a collection of contacts 410 arranged on both faces the PCB 130. The contacts 410 include solder pads and through-hole pads that can be used to electrically and mechanically connect the switch 110 to the PCB 130. For example, some of the pins 111 can be soldered directly to ones of the contacts 410, and some of the pins 111 can be electrically connected to ones of the contacts 410 by jumper wires. In the illustrated examples, the PCB 130 is configured to have a thickness based on a spacing between ones of the pins 111, such that ones of the pins 111 can contact corresponding ones of the contacts 410 on opposite faces of the PCB 130.

Also visible in these views are a collection of input/output contacts 420. In some embodiments, the contacts 420 can be the example input/output contacts 330 of FIG. 3. The input/output contacts 420 are configured to electrically and communicatively couple the PCB 130 to a power and communication bus (e.g., the communication bus 202). For example, CANBUS communication uses four wires (e.g., power, ground, CAN high, CAN low) to provide power and communications, and the PCB 130 can be configured with four of the contacts 420 to enable the switch assembly 100 to participate as a CANBUS node on a CANBUS network.

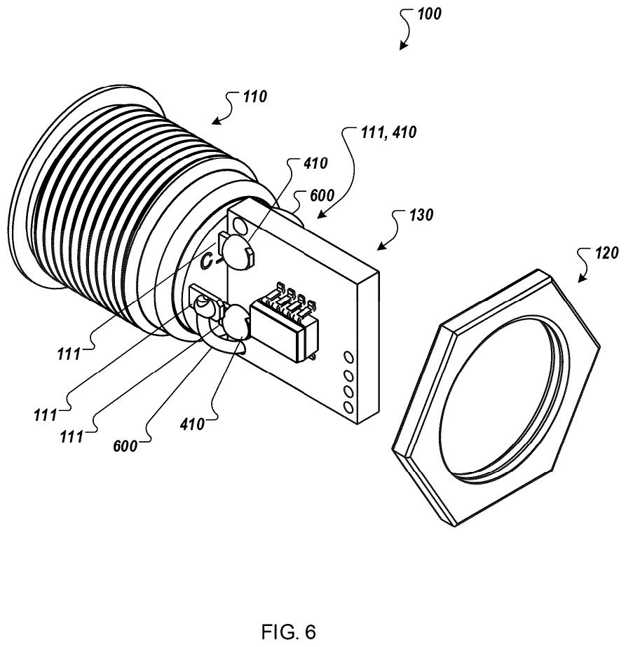

FIG. 6 is another exploded perspective rear view of the example switch assembly. In the illustrated example, the PCB 130 has been arranged between ones of the pins 111, and the ones of the pins 111 have been soldered to the contacts 410. Such an arrangement not only provides electrical communication between the switch 110 and the PCB 130, it also mechanically affixes the PCB 130 to the switch 110. Others of the pins 111 are electrically connected to ones of the contacts 410 by jumper wires 600.

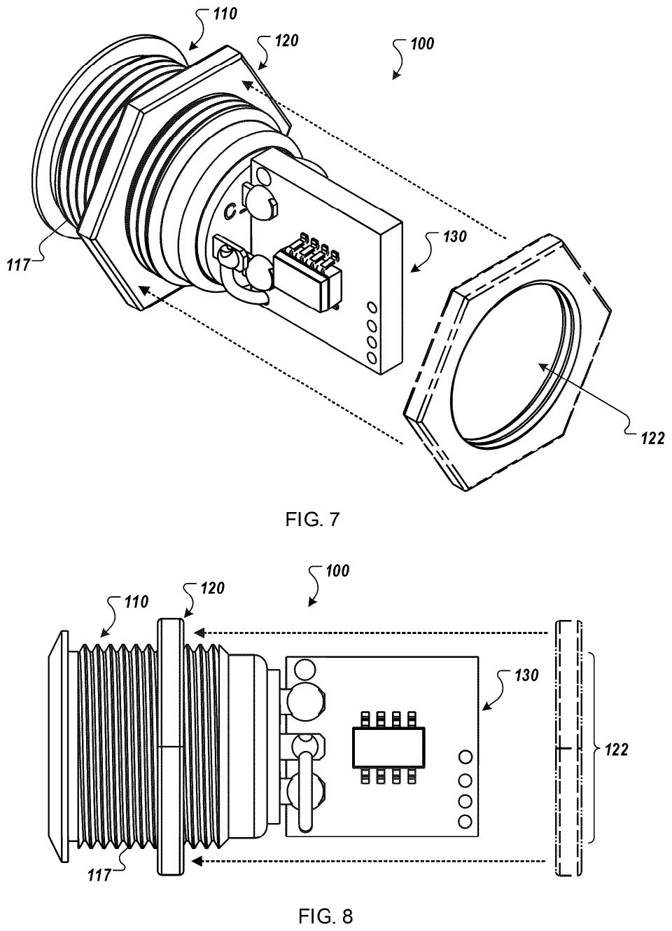

FIG. 7 is another exploded perspective rear view of the example switch assembly 100. FIG. 8 is another exploded side view of the example switch assembly 100. In the illustrated examples, the nut 120 is passed over the PCB 130 (e.g., the PCB 130 is passed through the threaded hole 122) and is threaded onto the thread 117 of the switch 110.

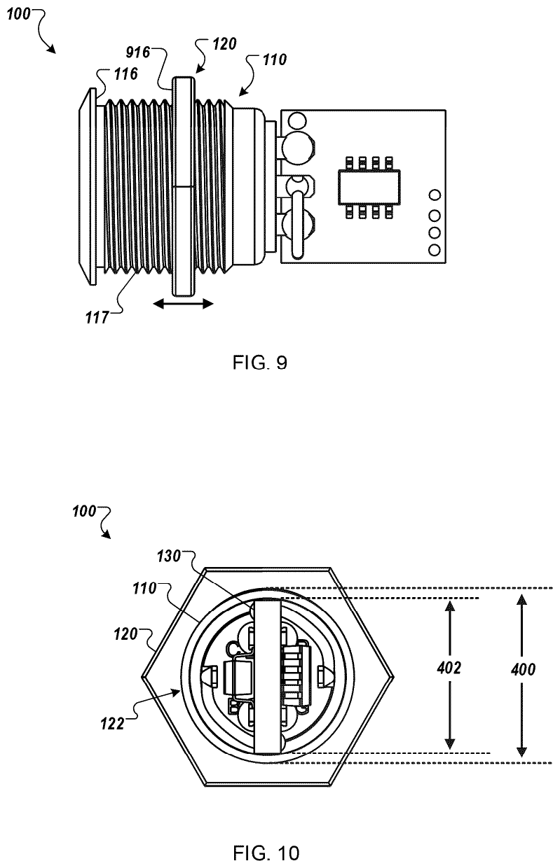

FIG. 9 is another side view of the example switch assembly 100. The nut 120 may rotated to adjust its axial position along the thread 117 to adjust a spacing between the shoulder 116 and a face 916 of the nut 120. In use, the switch assembly 100 is inserted into a mounting hole in the surface of a panel (e.g., control panel, user interface). The shoulder 116 abuts a front face of the panel to partly retain the switch assembly 100 to the panel (e.g., by preventing the switch 110 from falling through the hole), and the nut 120 is threaded onto the switch 110 until it abuts an opposing rear face of the panel and tightened to partly retain the switch assembly 100 to the panel (e.g., by preventing the switch 110 from falling out of the hole).

FIG. 10 is a rear view of the example switch assembly 100. Visible again in this view is how the diameter 400 of the threaded hole 122 is larger than the largest dimension 402 of the PCB 130. This allows the PCB 130 to be passed through the threaded hole 122 as the nut 120 is assembled to the switch 110.

In some embodiments, the PCB 130 can include one or more connectors. For example, a multi-conductor latching socket can be included on the PCB 130 to facilitate pluggable connection to a communication network. In some embodiments, connection leads could be supplied that transition from the PCB 130 or a connector mounted on the PCB 130 to a different connector or conductor type. For example, standard OBD-II connectors are generally too large to be mounted directly on the PCB 130, so a smaller connector may be provided on the PCB 130 and a jumper or adapter can be used to convert the small connector to a standard OBD-II type connector.

In some embodiments, the PCB 130 can include one or more power regulators to regulate or condition incoming power and provide other internal electronic components with safe levels of power. Power regulators or other electronic components can generate heat as they function, and in some embodiments the PCB 130 can include heat-dissipating components. For example, the PCB 130 can include metallic electrical traces that are sufficiently wide, long, and/or thick to act as heat pipes or heat sinks to conduct heat away from heat-generating components and allow the heat to dissipate into ambient air. In another example, the housing 111 can be arranged in direct or indirect thermal communication with heat-generating components, such that the housing 111 (e.g., and in some examples, the panel it is affixed to) can act as a heat sink to dissipate heat generated by the PCB 130.

In some embodiments, the PCB 130 can be configured to provide other functions, such as:

Count Switch Actuations: The PCB 130 can be configured to count the actuations of the switch 110 and transmit messages that notify other systems that the switch 110 may be nearing the end of its rated life, and/or the configurable illuminator 112 can be flashed or illuminated with a predetermined color to indicate end of life.

Control switch state: The PCB 130 can be configured to override a switch state (e.g., to avert a problem).

Low-cost toggle switch: The PCB 130 can be configured to add a toggle function to momentary contact switches.

Set actuation frequency limits: In some embodiments, the PCB 130 can be adapted to monitor other types of switches and/or sensors (e.g., digital or analog). For example, the PCB 130 can be configured to monitor the speed of a rotating shaft, with predetermined upper and/or lower rotation speed thresholds and preconfigured messages that can be sent in response to the PCB 130 determining that one or either of the speed threshold values has been crossed. In another example, the PCB 130 can be configured to monitor a fluid level sensor and send a predetermined message when the sensor is triggered or released. In yet another example, the PCB 130 can be configured to monitor an analog signal, such as a thermocouple or temperature sensor signal, a pressure sensor signal, a voltage level, or a current transducer signal, and send one or more predetermined messages when the monitored signal crosses one or more predetermined analog signal threshold levels.

Lockout: The PCB 130 can be configured to prevent accidental activation. For example, the PCB 130 can be configured to require that switch be depressed for a predetermined period of time before the user input is recognized (e.g., the switch 110 has to be pressed for five seconds in order to start restart a process after an emergency stop). In some embodiments, the PCB 130 can be configured with built-in delays to make it difficult or impossible for a user to press the switch 110 too quickly (e.g., to prevent damage from incomplete power up/down sequences).

System lockout: The PCB 130 can be configured to lockout switch activations during critical modes of operation.

Debounce: The PCB 130 can be configured to provide switch debounce, to prevent a single user input from being misinterpreted as a rapid series of switching events. Switch bounce is not well understood by some hardware and software integrators, and in some situations such lack of understanding can result in solutions that may exhibit erratic unpredictable behavior that is difficult to debug in the field.

In various example embodiments, switch debounce is embedded into the switch assembly (e.g., an no debounce is necessary at a separate controller or other listener). While there are well documented hardware and controller software debounce solutions, there are several advantages to performing software debounce at the switch rather than at a controller or other listener. For example, by providing a self-debounced switch to software developers, the software developers can be relieved of the burden of need to become aware of and overcome the mechanical nature of the switch bounce problem and bounce characteristics. For example, software developers may be able to avoid attempts to implement proprietary solutions that fail to address corner cases. In another example, by providing a self-debounced switch, the complexity of the debounce software solutions can reduced (e.g., a complexity that might otherwise scale along with the number of switches to be handled). In another example, by providing a self-debounced switch, the performance controller processors can be improved (e.g., controller software-based debounce solutions that can waste processor capacity by constantly monitoring the state of switches can be avoided or omitted), and system reliability can be improved (e.g., by avoiding a potential risk of inadvertent system compromise that could be caused by a software update and missed in a subsequent system test, potentially resulting in field failures). In another example, by providing a self-debounced switch, system reliability can be increased by avoiding the use of proprietary software debounce techniques that may work initially but cease working as switches age, or original switches are replaced by new switches with different electrical characteristics.

Hardware debounce solutions can have several drawbacks of their own. For example, hardware debounce can adds extra components to the PCB, consuming area, increasing cost, increasing the component count, and reducing board reliability (e.g., every additional component and solder joint can add a potential point of failure). In another example, as with software debounce, hardware debounce may not work when switch characteristics change through switch aging or replacement.

By embedding switch debounce into the switch assembly 110, system design can be simplified and accelerated, and can reduce or eliminate the risk of switch bounce failures. In some implementations, these attributes can be crucial in mission-critical applications such as military, medical, control systems, robotics, and automotive, where switch bounce failures can be catastrophic.

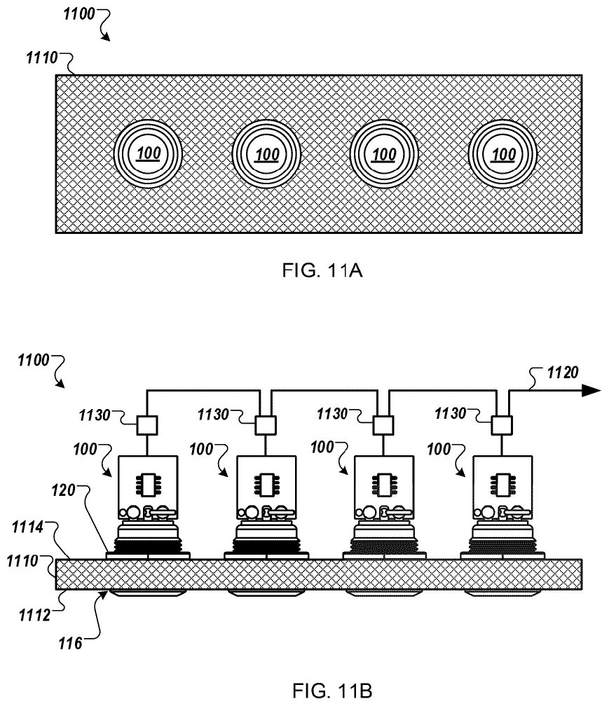

FIGS. 11A and 11B are front and top views of an example switch panel assembly 1100. In the illustrated examples, four of the example switch assemblies 100 have been partly inserted through apertures in a panel surface 1110 until the shoulders 116 abut a front face 1112 or surface of the panel 1110. The switch assemblies 100 are secured in place by tightening the nuts 120 until they abut a rear face 1114 or opposing surface of the panel 1110 such as the panel 1110 is compressed between the shoulder 116 and the nut 130.

Each of the switch assemblies 100 is electrically connected to a power and communication bus 1120. The connection is provided by a collection of Y-connectors 1130. Each of the connectors 1130 is electrically connected to a corresponding one of the switch assemblies 100 at one end and splits that connection into two connection points at the other end. In the illustrated example, the switch assemblies 100 are daisy-chained to the communication bus 1120, in which one of the switch assemblies 100 is coupled to its neighbor and the communication bus 1120 by a connector 1130. For example, in a CANBUS network, node devices (e.g., the switch assemblies 100) can be connected to the network by “teeing” off the bus.

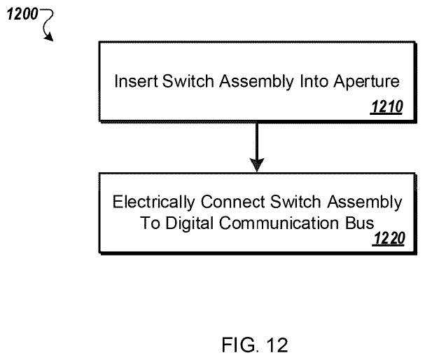

FIG. 12 is a flow diagram of an example process 1200 for assembling a switch assembly. In some implementations, the process 1200 can be performed using the example switch assembly 100 and the example panel 1110 of FIG. 11.

At 1210 an electrical switch assembly is inserted into an aperture defined a surface and configured to retain the electrical switch assembly. The electrical switch assembly includes an electrical switch, a communication transceiver electrically and mechanically coupled to the electrical switch and configured to transmit a digitally encoded representation of a configuration status of the electrical switch. For example, the housing 111 of the electrical switch assembly 100 can inserted through a corresponding hole formed in the panel 1110.

In some implementations, the process 1200 can include abutting a shoulder of a housing of the electrical switch against the surface, passing a nut over the communication transceiver such that the communication transceiver is at least partly passed through an aperture defined by the nut, threading the nut over a thread defined about an outer periphery of the housing, abutting the nut against an opposing face of the surface, and retaining the surface between the shoulder and the nut. For example, the switch housing 111 can be inserted into the panel until the shoulder 116 contacts the front face 1112 of the panel 1110, and the nut 120 can be passed over the PCB 130 and threaded onto the thread 117 until it contacts the rear face 1114 of the panel 1110.

At 1120, a digital communication bus is electrically connected to the electrical switch assembly. For example, the communication bus 1120 can be connected to the switch assembly 100 directly (e.g., to the contacts 420) or indirectly (e.g., through the connectors 1130).

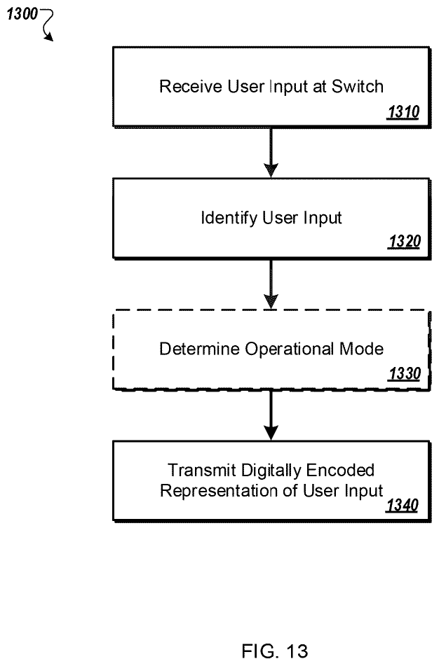

FIG. 13 is a flow diagram of an example process 1300 for using an example switch assembly. In some implementations, the process 1300 can be performed using the example switch assembly 100 and the example panel 1110 of FIG. 11.

At 1310, a user input is received at the switch assembly. For example, the user 201 can press the button 114.

At 1320 a communication transceiver electrically and mechanically coupled to the switch assembly identifies the user input. For example, the PCB 130 is electrically connected to the pins 111 such that the pins 111 provide electrical communication and physical support to the PCB 130. The PCB 130 can detect activation and release of the button 114.

At 1330, the communication transceiver transmits a digitally encoded representation of the user input. For example, upon detection of a press of the button 114, the PCB 130 can transmit a predetermined digital, serially encoded message on the communication bus 202, and upon detection of a release of the button 114, the PCB 130 can transmit the same or a different predetermined digital, serially encoded message on the communication bus 202.

In some implementations, the process 1300 can include receiving, by the communication transceiver, an illumination command, and modify an illumination configuration of a configurable illuminator of the switch assembly based on the illumination command. For example, the PCB 130 can receive (e.g., from the communication bus 202) a message that represents “flash blue”, and the PCB 130 can respond by controlling the configurable illuminator 112 to illuminate with a blue hue that is pulsed on and off.

In some implementations, the process 1300 can include receiving, by the communication transceiver, a switch configuration parameter, where the digitally encoded representation of the user input is based on the received switch configuration parameter. For example, the programmer 240 can send a message to the switch assembly 210 that configures the switch assembly 210 to send a selected message across the communication bus 202 when the user 201 presses a button on the switch assembly 210.

In some implementations, the process 1300 can include receiving a switch configuration parameter, where the digitally encoded representation is based on the switch configuration parameter. For example, the switch assembly 100 can be configured to send one type of message when the button 114 is depressed, send a different type of message when the button is released, and send yet other different types of messages when the button 114 is pressed multiple times in a row.

In some implementations, the process 1300 can include one or more of determining that the switch configuration parameter is indicative of a first operational mode, and transmitting a first message as the digitally encoded representation of a configuration status in response to a first press of the switch assembly, determining that the switch configuration parameter is indicative of a second operational mode, transmitting the first message as the digitally encoded representation of the configuration status in response to the first press of the switch assembly, and transmitting a second message as the digitally encoded representation of a configuration status in response to a first release of the switch assembly, determining that the switch configuration parameter is indicative of a third mode, transmitting the first message as the digitally encoded representation of the configuration status in response to the first press of the switch assembly, and transmitting the second message as the digitally encoded representation of the configuration status in response to a second press of the switch assembly, and determining that the switch configuration parameter is indicative of a fourth mode, transmitting first message as the digitally encoded representation of the configuration status in response to the first press of the switch assembly, transmitting the second message as the digitally encoded representation of the configuration status in response to the first release of the switch assembly, transmitting a third message as the digitally encoded representation of the configuration status in response to the second press of the switch assembly, and transmitting a fourth message as the digitally encoded representation of the configuration status in response to a second release of the switch assembly.

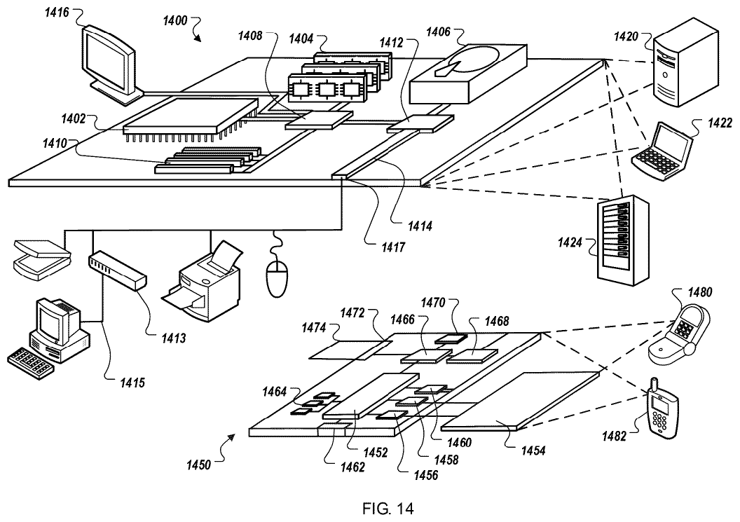

FIG. 14 is a block diagram of computing devices 1400, 1450 that may be used to implement the systems and methods described in this document, either as a client or as a server or plurality of servers. Computing device 1400 is intended to represent various forms of digital computers, such as laptops, desktops, workstations, personal digital assistants, servers, blade servers, mainframes, and other appropriate computers. Computing device 1400 can also represent all or parts of various forms of computerized devices, such as embedded digital controllers, media bridges, modems, network routers, network access points, network repeaters, and network interface devices including mesh network communication interfaces. Computing device 1450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1400 includes a processor 1402, a memory 1404, a storage device 1406, a high-speed interface 1408 connecting to memory 1404 and high-speed expansion ports 1410, and a low speed interface 1412 connecting to a low speed bus 1414 and storage device 1406. Each of the components 1402, 1404, 1406, 1408, 1410, and 1412, are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high speed interface 1408. In other implementations, multiple processors and/or multiple buses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1404 stores information within the computing device 1400. In one implementation, the memory 1404 is a computer-readable medium. In one implementation, the memory 1404 is a volatile memory unit or units. In another implementation, the memory 1404 is a non-volatile memory unit or units.

The storage device 1406 is capable of providing mass storage for the computing device 1400. In one implementation, the storage device 1406 is a computer-readable medium. In various different implementations, the storage device 1406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 1404, the storage device 1406, or memory on processor 1402.

The high speed controller 1408 manages bandwidth-intensive operations for the computing device 1400, while the low speed controller 1412 manages lower bandwidth-intensive operations. Such allocation of duties is exemplary only. In one implementation, the high-speed controller 1408 is coupled to memory 1404, display 1416 (e.g., through a graphics processor or accelerator), and to high-speed expansion ports 1410, which may accept various expansion cards (not shown). In the implementation, low-speed controller 1412 is coupled to storage device 1406 and low-speed expansion port 1417 through the low-speed bus 1414. The low-speed expansion port, which may include various communication ports (e.g., Universal Serial Bus (USB), BLUETOOTH, BLUETOOTH Low Energy (BLE), Ethernet, wireless Ethernet (Wi-Fi), High-Definition Multimedia Interface (HDMI), ZIGBEE, visible or infrared transceivers, Infrared Data Association (IrDA), fiber optic, laser, sonic, ultrasonic) may be coupled to one or more input/output devices, such as a keyboard, a pointing device, a scanner, a networking device such as a gateway, modem, switch, or router, e.g., through a network adapter 1413.

Peripheral devices can communicate with the high speed controller 1408 through one or more peripheral interfaces of the low speed controller 1412, including but not limited to a CANBUS stack, a MODBUS stack, and I2C stack, a USB stack, an Ethernet stack, a Wi-Fi radio, a BLUETOOTH Low Energy (BLE) radio, a ZIGBEE radio, a THREAD radio, an HDMI stack, and a BLUETOOTH radio, as is appropriate for the configuration of the particular sensor. For example, a sensor that outputs a reading over a USB cable can communicate through a USB stack.

The network adapter 1413 can communicate with a network 1415. Computer networks typically have one or more gateways, modems, routers, media interfaces, media bridges, repeaters, switches, hubs, Domain Name Servers (DNS), and Dynamic Host Configuration Protocol (DHCP) servers that allow communication between devices on the network and devices on other networks (e.g., the Internet). One such gateway can be a network gateway that routes network communication traffic among devices within the network and devices outside of the network. One common type of network communication traffic that is routed through a network gateway is a Domain Name Server (DNS) request, which is a request to the DNS to resolve a uniform resource locator (URL) or uniform resource indicated (URI) to an associated Internet Protocol (IP) address.

The network 1415 can include one or more networks. The network(s) may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication may occur through a radio-frequency transceiver. In addition, short-range communication may occur, such as using a BLUETOOTH, BLE, ZIGBEE, Wi-Fi, IrDA, or other such transceiver.

In some embodiments, the network 1415 can have a hub-and-spoke network configuration. A hub-and-spoke network configuration can allow for an extensible network that can accommodate components being added, removed, failing, and replaced. This can allow, for example, more, fewer, or different devices on the network 1415. For example, if a device fails or is deprecated by a newer version of the device, the network 1415 can be configured such that network adapter 1413 can be updated about the replacement device.

In some embodiments, the network 1415 can have a mesh network configuration (e.g., ZIGBEE). Mesh configurations may be contrasted with conventional star/tree network configurations in which the networked devices are directly linked to only a small subset of other network devices (e.g., bridges/switches), and the links between these devices are hierarchical. A mesh network configuration can allow infrastructure nodes (e.g., bridges, switches, and other infrastructure devices) to connect directly and non-hierarchically to other nodes. The connections can be dynamically self-organized and self-configured to route data. By not relying on a central coordinator, multiple nodes can participate in the relay of information. In the event of a failure of one or more of the nodes or the communication links between then, the mesh network can self-configure to dynamically redistribute workloads and provide fault-tolerance and network robustness.

The computing device 1400 may be implemented in a number of different forms, as shown in the figure. For example, it may be implemented as a standard server 1420, or multiple times in a group of such servers. It may also be implemented as part of a rack server system 1424. It may also be implemented as part of network device such a modem, gateway, router, access point, repeater, mesh node, switch, hub, or security device (e.g., camera server). In addition, it may be implemented in a personal computer such as a laptop computer 1422. Alternatively, components from computing device 1400 may be combined with other components in a mobile device (not shown), such as device 1450. In some embodiments, the device 1450 can be a mobile telephone (e.g., a smartphone), a handheld computer, a tablet computer, a network appliance, a camera, an enhanced general packet radio service (EGPRS) mobile phone, a media player, a navigation device, an email device, a game console, an interactive or so-called “smart” television, a media streaming device, or a combination of any two or more of these data processing devices or other data processing devices. In some implementations, the device 1450 can be included as part of a motor vehicle (e.g., an automobile, an emergency vehicle (e.g., fire truck, ambulance), a bus). Each of such devices may contain one or more of computing device 1400, 1450, and an entire system may be made up of multiple computing devices 1400, 1450 communicating with each other through a low speed bus or a wired or wireless network.

Computing device 1450 includes a processor 1452, memory 1464, an input/output device such as a display 1454, a communication interface 1466, and a transceiver 1468, among other components. The device 1450 may also be provided with a storage device, such as a microdrive or other device, to provide additional storage. Each of the components 1450, 1452, 1464, 1454, 1466, and 1468, are interconnected using various buses, and several of the components may be mounted on a common motherboard or in other manners as appropriate.

The processor 1452 can process instructions for execution within the computing device 1450, including instructions stored in the memory 1464. The processor may also include separate analog and digital processors. The processor may provide, for example, for coordination of the other components of the device 1450, such as control of user interfaces, applications run by device 1450, and wireless communication by device 1450. Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. The essential elements of a computer are a processor for executing instructions and one or more memories for storing instructions and data. The processor can be supplemented by, or incorporated in, ASICs (application-specific integrated circuits), FPGAs (field programmable gate arrays), PLDs (programmable logic devices)

Processor 1452 may communicate with a user through control interface 1458 and display interface 1456 coupled to a display 1454. The display 1454 may be, for example, a TFT LCD display or an OLED display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provided in communication with processor 1452, so as to enable near area communication of device 1450 with other devices. External interface 1462 may provide, for example, for wired communication (e.g., via a docking procedure) or for wireless communication (e.g., via Bluetooth or other such technologies).

The memory 1464 stores information within the computing device 1450. In one implementation, the memory 1464 is a computer-readable medium. In one implementation, the memory 1464 is a volatile memory unit or units. In another implementation, the memory 1464 is a non-volatile memory unit or units. Expansion memory 1474 may also be provided and connected to device 1450 through expansion interface 1472, which may include, for example, a SIMM card interface. Such expansion memory 1474 may provide extra storage space for device 1450 or may also store applications or other information for device 1450. Specifically, expansion memory 1474 may include instructions to carry out or supplement the processes described above and may also include secure information. Thus, for example, expansion memory 1474 may be provided as a security module for device 1450 and may be programmed with instructions that permit secure use of device 1450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, or memory on processor 1452.

Device 1450 may communicate wirelessly through communication interface 1466, which may include digital signal processing circuitry where necessary. Communication interface 1466 may provide for communications under various modes or protocols, such as GSM voice calls, Voice Over LTE (VOLTE) calls, SMS, EMS, or MMS messaging, CDMA, TDMA, PDC, WCDMA, CDMA2000, GPRS, WiMAX, LTE, 4G, and/or 5G, among others. Such communication may occur, for example, through radio-frequency transceiver 1468. In addition, short-range communication may occur, such as using a Bluetooth, Wi-Fi, or other such transceiver (not shown) configured to provide uplink and/or downlink portions of data communication. In addition, GPS receiver module 1470 may provide additional wireless data to device 1450, which may be used as appropriate by applications running on device 1450.

Device 1450 may also communication audibly using audio codec 1460, which may receive spoken information from a user and convert it to usable digital information. Audio codex 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in the figure. For example, it may be implemented as a cellular telephone 1480. It may also be implemented as part of a smartphone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

Some communication networks can be configured to carry power as well as information on the same physical media. This allows a single cable to provide both data connection and electric power to devices. Examples of such shared media include power over network configurations in which power is provided over media that is primarily or previously used for communications. One specific embodiment of power over network is Power Over Ethernet (POE) which pass electric power along with data on twisted pair Ethernet cabling. Examples of such shared media also include network over power configurations in which communication is performed over media that is primarily or previously used for providing power. One specific embodiment of network over power is Power Line Communication (PLC) (also known as power-line carrier, power-line digital subscriber line (PDSL), mains communication, power-line telecommunications, or power-line networking (PLN), Ethernet-Over-Power (EOP)) in which data is carried on a conductor that is also used simultaneously for AC electric power transmission.

The computing system can include clients and servers. A client and server are generally remote from each other and typically interact through a communication network. The relationship of client and server arises by virtue of computer programs running on the respective computers and having a client-server relationship to each other.

The computing system can include routers, gateways, modems, switches, hub, bridges, and repeaters. A router is a networking device that forwards data packets between computer networks and performs traffic directing functions. A network switch is a networking device that connects networked devices together by performing packet switching to receive, process, and forward data to destination devices. A gateway is a network device that allows data to flow from one discrete network to another. Some gateways can be distinct from routers or switches in that they can communicate using more than one protocol and can operate at one or more of the seven layers of the open systems interconnection model (OSI). A media bridge is a network device that converts data between transmission media so that it can be transmitted from computer to computer. A modem is a type of media bridge, typically used to connect a local area network to a wide area network such as a telecommunications network. A network repeater is a network device that receives a signal and retransmits it to extend transmissions and allow the signal can cover longer distances or overcome a communications obstruction.

As used herein, the terms “circuit” or “circuitry” are used to mean any and every electronic or electrical device (including not only discrete hardware components, but also programmable devices such as a PLD, software executed by a general purpose or special purpose microprocessor, or the like. Nothing in this document, except where otherwise indicated, can be used to suggest that functionality described herein is necessarily implemented purely by hardware components.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

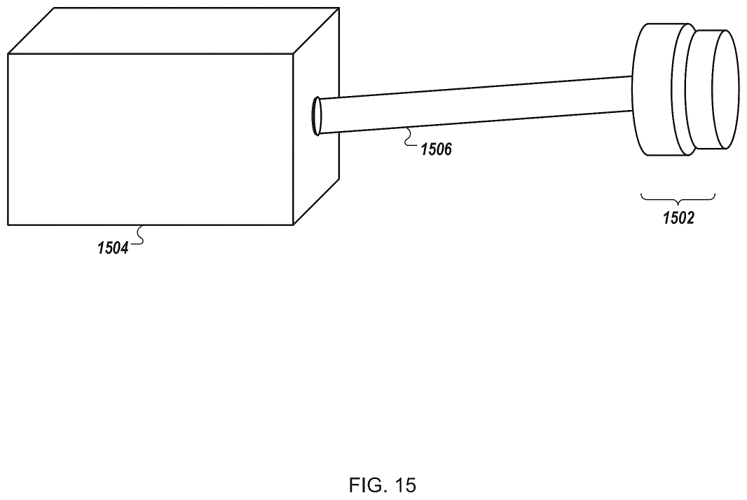

FIG. 15 is a perspective side view of an example 1500 switch assembly. In the illustrated example, the assembly 1500 is an electrical switch apparatus that includes a mountable pushbutton electrical switch 1502 operatively coupled with a control box 1504 via a data cable 1506. In various implementations, portions of the example 1500 can include mounting hardware including tapped holes and/or mating surfaces to detachably couple portions of the example 1500 to other hardware including, but not limited to, portions of a panel, control box, etc.

The control box 1504 can include, for example, a communication transceiver configured as a printed circuit board (PCB). One or more wires can traverse the data cable to communicably connect pins of the PCT with the backside of the switch 1502.

As will be appreciated, the arrangement of data cable 1506 and control box 1504 can be compatible with various example switch assemblies. For example, the example 1500 can include the switch assembly 100, providing greater versatility in mounting options, providing encapsulation to protect from environmental hazards such as dust and physical shock, etc., and/or facilitate thermal management.

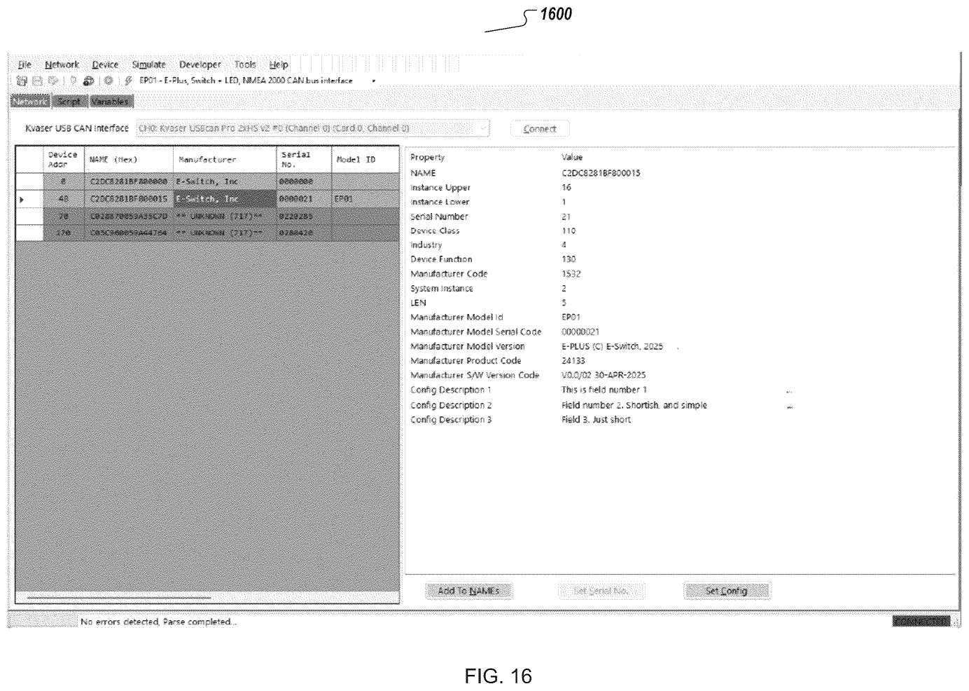

FIG. 16 is an example user interface 1600 for programming a switch assembly. For example, the user interface can include interface elements to identify one or more switch assemblies on a data network, select one of those switch assemblies for programming, and to supply user inputs to program the switch assembly.

1. An electrical switch assembly comprising:
an electrical switch; and
a communication transceiver electrically and mechanically coupled to the electrical switch and configured to transmit a digitally encoded representation of a configuration status of the electrical switch.

2. The electrical switch assembly of claim 1, wherein the electrical switch comprises a configurable illuminator and the communication transceiver is further configured to receive an illumination command and modify an illumination configuration of the configurable illuminator based on the illumination command.

3. The electrical switch assembly of claim 1, wherein the communication transceiver is further configured to receive a switch configuration parameter, wherein the digitally encoded representation is based on the switch configuration parameter.

4. The electrical switch assembly of claim 3, wherein the switch configuration parameter comprises an indication of one or more of:
a first operational mode, wherein a first message is transmitted as the digitally encoded representation of the configuration status in response to a first press of the electrical switch;
a second operational mode, wherein the first message is transmitted as the digitally encoded representation of the configuration status in response to the first press of the electrical switch, and a second message is transmitted as the digitally encoded representation of the configuration status in response to a first release of the electrical switch;
a third operational mode, wherein the first message is transmitted as the digitally encoded representation of the configuration status in response to the first press of the electrical switch, and the second message is transmitted as the digitally encoded representation of the configuration status in response to a second press of the electrical switch; and
a fourth operational mode, wherein the first message is transmitted as the digitally encoded representation of the configuration status in response to the first press of the electrical switch, the second message is transmitted as the digitally encoded representation of the configuration status in response to the first release of the electrical switch, a third message is transmitted as the digitally encoded representation of the configuration status in response to the second press of the electrical switch, and a fourth message is transmitted as the digitally encoded representation of the configuration status in response to a second release of the electrical switch.

5. The electrical switch assembly of claim 1, wherein the digitally encoded representation of a configuration status comprises a message that is machine-readable by a remote device.

6. A method of assembling an electrical assembly, the method comprising:
inserting an electrical switch assembly into an aperture defined a surface and configured to retain the electrical switch assembly, wherein the electrical switch assembly comprises:
an electrical switch;
a communication transceiver electrically and mechanically coupled to the electrical switch and configured to transmit a digitally encoded representation of a configuration status of the electrical switch; and
electrically connecting a digital communication bus to the electrical switch assembly.

7. The method of claim 6, further comprising:
abutting a shoulder of a housing of the electrical switch against the surface;
passing a nut over the communication transceiver such that the communication transceiver is at least partly passed through an aperture defined by the nut;
threading the nut over a thread defined about an outer periphery of the housing;
abutting the nut against an opposing face of the surface; and
retaining the surface between the shoulder and the nut.

8. A method of operating a switch assembly, the method comprising:
receiving a user input at the switch assembly;
identifying, by a communication transceiver electrically and mechanically coupled to the switch assembly, the user input; and
transmitting, by the communication transceiver, a digitally encoded representation of the user input.

9. The method of claim 8, further comprising:
receiving, by the communication transceiver, an illumination command; and
modify an illumination configuration of a configurable illuminator of the switch assembly based on the illumination command.

10. The method of claim 8, further comprising receiving, by the communication transceiver, a switch configuration parameter, wherein the digitally encoded representation of the user input is based on the received switch configuration parameter.

11. The method of claim 10, further comprising receiving a switch configuration parameter, wherein the digitally encoded representation is based on the switch configuration parameter.

12. The method of claim 11, further comprising one or more of:
determining that the switch configuration parameter is indicative of a first operational mode, and transmitting a first message as the digitally encoded representation of a configuration status in response to a first press of the switch assembly;
determining that the switch configuration parameter is indicative of a second operational mode, transmitting the first message as the digitally encoded representation of the configuration status in response to the first press of the switch assembly, and transmitting a second message as the digitally encoded representation of a configuration status in response to a first release of the switch assembly;
determining that the switch configuration parameter is indicative of a third mode, transmitting the first message as the digitally encoded representation of the configuration status in response to the first press of the switch assembly, and transmitting the second message as the digitally encoded representation of the configuration status in response to a second press of the switch assembly; and
determining that the switch configuration parameter is indicative of a fourth mode, transmitting first message as the digitally encoded representation of the configuration status in response to the first press of the switch assembly, transmitting the second message as the digitally encoded representation of the configuration status in response to the first release of the switch assembly, transmitting a third message as the digitally encoded representation of the configuration status in response to the second press of the switch assembly, and transmitting a fourth message as the digitally encoded representation of the configuration status in response to a second release of the switch assembly.

13. An electrical switch apparatus comprising:
an electrical switch;
one or more processors;
a non-transitory, computer-readable medium storing one or more machine-readable instructions that, when executed, cause the one or more processors to perform operations comprising:
receiving a user input at the electrical switch;
identifying, by a communication transceiver electrically and mechanically coupled to the electrical switch, the user input; and
transmitting, by the communication transceiver, a digitally encoded representation of the user input.

14. The electrical switch apparatus of claim 13, wherein the electrical switch comprises a configurable illuminator and the communication transceiver is further configured to receive an illumination command and modify an illumination configuration of the configurable illuminator based on the illumination command.

15. The electrical switch apparatus of claim 13, wherein the communication transceiver is further configured to receive a switch configuration parameter, wherein the digitally encoded representation is based on the switch configuration parameter.

16. The electrical switch apparatus of claim 15, the operations further comprising one or more of:
determining that the switch configuration parameter is indicative of a first operational mode, and transmitting a first message as the digitally encoded representation of a configuration status in response to a first press of the electrical switch apparatus;
determining that the switch configuration parameter is indicative of a second operational mode, transmitting the first message as the digitally encoded representation of the configuration status in response to the first press of the electrical switch apparatus, and transmitting a second message as the digitally encoded representation of a configuration status in response to a first release of the electrical switch apparatus;
determining that the switch configuration parameter is indicative of a third mode, transmitting the first message as the digitally encoded representation of the configuration status in response to the first press of the electrical switch apparatus, and transmitting the second message as the digitally encoded representation of the configuration status in response to a second press of the electrical switch apparatus; and
determining that the switch configuration parameter is indicative of a fourth mode, transmitting first message as the digitally encoded representation of the configuration status in response to the first press of the electrical switch apparatus, transmitting the second message as the digitally encoded representation of the configuration status in response to the first release of the electrical switch apparatus, transmitting a third message as the digitally encoded representation of the configuration status in response to the second press of the electrical switch apparatus, and transmitting a fourth message as the digitally encoded representation of the configuration status in response to a second release of the electrical switch apparatus.

17. The electrical switch apparatus of claim 13, wherein the digitally encoded representation of a configuration status comprises a message that is machine-readable by a remote device.

18. The electrical switch apparatus of claim 13, the operations further comprising:
receiving, by the communication transceiver, an illumination command; and
modify an illumination configuration of a configurable illuminator of the electrical switch apparatus based on the illumination command.

19. The electrical switch apparatus of claim 18, the operations further comprising receiving, by the communication transceiver, a switch configuration parameter, wherein the digitally encoded representation of the user input is based on the received switch configuration parameter.

20. The electrical switch apparatus of claim 13, the operations further comprising receiving a switch configuration parameter, wherein the digitally encoded representation is based on the switch configuration parameter.
